(19) United States
(12) Patent Application Publication
(10) Pub. No.: US 2026/0088050 A1
(43) Pub. Date: Mar. 26, 2026

(54) SYSTEMS AND METHODS FOR GENERATING VIDEO CONTENT USING NATURAL LANGUAGE

(71) Applicant: Ritual Ads, Inc., Beverly Hills, CA (US)

(72) Inventor: Jethro Rothe-Kushel, Beverly Hills, CA (US)

(21) Appl. No.: 19/369,105

(22) Filed: Oct. 24, 2025

Related U.S. Application Data
(63) Continuation-in-part of application No. 19/334,618, filed on Sep. 19, 2025.
(60) Provisional application No. 63/696,897, filed on Sep. 20, 2024.

(51) Int. Cl. G11B 27/031; G06F 40/40; G06T 11/00; G06T 13/00

(52) U.S. Cl. CPC G11B 27/031; G06F 40/40; G06T 11/00; G06T 13/00

(57) ABSTRACT

A computer implemented method for generating video content based on natural language input is disclosed. The method includes receiving a natural language instruction describing one or more desired characteristics of a video. A structured script file comprising at least one story beat is generated using a natural language processing engine. A storyboard comprising one or more storyboard frames is created based on the structured script file. One or more virtual components are generated based on the storyboard. An intermediate video sequence comprising a visual component and an auditory component is created using virtual components and the storyboard. The intermediate video sequence is then refined to produce a modified video sequence by applying one or more post-processing effects.

### CROSS-REFERENCE TO RELATED APPLICATIONS

This application is a continuation in part and claims the benefit of U.S. Non-Provisional application Ser. No. 19/334,618, filed Sep. 19, 2025, which claims priority to U.S. Provisional Application No. 63/696,897, filed Sep. 20, 2024, all of which are hereby incorporated by reference, to the extent that they are not conflicting with the present application.

### BACKGROUND OF INVENTION

### 1. Field of the Invention

The invention relates generally to artificial intelligence systems. More specifically the invention relates to generative artificial intelligence systems.

### 2. Description of the Related Art

Traditional video production requires extensive human labor, coordination across multiple teams, and significant costs. Existing solutions used for video content creation often focus on individual steps in the larger process such as script writing, storyboarding, editing, audio effects, video effects, market testing, or distribution. Additionally, these existing solutions require significant human intervention and may not be operable by a lay person. This fragmented approach and need for tool expertise leads to inefficiencies in production, increased costs, and prolonged timelines. Furthermore, current video content creation procedure, involving tool specific experts, physical sets and human actors, is not sufficiently scalable. Therefore, there is a need for a streamlined end-to-end video content creation solution operable by a lay person. Such a solution may be used to reduce costs, accelerate production timelines, and scale content creation for industries such as advertising, entertainment, and education.

The aspects or the problems and the associated solutions presented in this section could be or could have been pursued; they are not necessarily approaches that have been previously conceived or pursued. Therefore, unless otherwise indicated, it should not be assumed that any of the approaches presented in this section qualify as prior art merely by virtue of their presence in this section of the application.

### BRIEF INVENTION SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

The invention addresses the high costs, long production timelines, and extensive human labor required for traditional content creation in the film and television industries. It addresses inefficiencies present in scriptwriting, pre-production planning, filming, and post-production, which often require the collaboration of large teams and significant resources. Additionally, it tackles the challenge of scaling content production while maintaining high quality, making it easier for creators to meet the increasing demand for diverse and engaging video content.

This invention improves upon existing solutions by offering an integrated, end-to-end natural language operated solution for video content creation. The systems and methods disclosed herein may be used to produce several useful items, including video content (e.g., films, commercials, training videos, or social media content), scripts, visual storyboards, virtual assets (e.g., digital environments, characters, sets) to be used within virtual reality (VR), video games, or augmented reality (AR), and personalized content.

The systems and methods disclosed herein may comprise the following components and steps. A user input interface may serve as the starting point of the process, where users provide essential parameters such as genre, theme, and character traits. The text input from this step is passed to the natural language processing (NLP) engine. The natural language processing engine may generate a structured narrative script. The structured script may be further refined by a script refinement module. The script refinement module may make modifications to the script based on user specified tone, pacing, and genre specific elements. Once the script is finalized, it may be passed to a storyboarding module. The storyboarding module may generate visual storyboards, which include camera angles, scene composition, and lighting plans. Based on the script and storyboard, a pre-production planning module may automate scheduling, budgeting, and casting decisions. The pre-production planning module may then pass the optimized production plan to a virtual production subsystem. The virtual component production module may create and manage virtual production components such as sets and actors, using the storyboard and the production plan. The virtual components (e.g., characters, objects and set pieces) may be animated through the virtual component animation module using pre-trained models or motion-capture data. These animated scenes may then be sent to a post-production module which may complete video editing, special effects, and sound mixing. The finished video content may then be reviewed by two supplemental modules. First, a market testing module may be used to predict the reaction of different audience demographics based on historical data and feedback. Second, based upon the results of the market testing module, a distribution optimization module may suggest optimal distribution channels in order to ensure the generated content reaches the largest audience possible. The components may operate in a sequential or parallel manner and may enable video content creation without significant human creative intervention.

In sum, the systems and methods disclosed herein provide for a natural language operated end-to-end solution for video content creation that streamlines what would traditionally be a labor-intensive, time-consuming process.

The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments, or examples of the invention are illustrated in the figures of the accompanying drawings, in which:

FIGS. 1A-D illustrates charts of performance metric improvements at each stage of the content creation process, associated with use of the disclosed invention. The data shown in FIGS. 1A-1D is for illustrative purposes and does not represent empirical third-party data.

FIGS. 2A-D each illustrate a flowchart or block diagram of a rough process flow of a system and method for generating video content using natural language, according to an aspect.

FIGS. 3A-B each depict flow charts of portions of the video content editing process withing a system and method for generating video content using natural language, according to an aspect.

### DETAILED DESCRIPTION

What follows is a description of various aspects, embodiments, and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

It should be understood that, for clarity of the drawings and of the specification, some or all details about some structural components or steps that are known in the art are not shown or described if they are not necessary for the invention to be understood by one of ordinary skills in the art.

As previously stated, the systems and methods disclosed herein may comprise the following components: a user input interface, a natural language processing engine, a script refinement module, a storyboarding module, a pre-production module, a virtual component

The user input interface may be configured to receive user input in the form of natural language. User input may comprise desired content format (e.g., .jpeg, .png, .mp4, .mov), genre, theme, character traits, plot points, color scheme, and pacing. An exemplary user input may be (“Create an advertisement to be posted on Instagram and TikTok for a new soft drink”). While the user input interface may be primarily operated using natural language, it may additionally receive photographs, videos, or audio recordings as well. In some embodiments, the user input interface may be built using web technologies such as React or Django. The user input interface may be a chat-style composer (e.g., multiline text box) or a guided form that allows the user to specify video content variables (e.g., brand, objective, tone, length, platforms, target audience age, target audience interest). The user input interface may additionally be configured to receive URLs, .pdf, or .doc files.

A natural language processing (NLP) engine or large language model (LLM) may process the extracted user input. Exemplary LLMs that may be utilized include ChatGPT models, Llama family models, Mistral family models, or Claude family models. The NLP or LLM may take the user input and generate a structured narrative script. The LLM may parse natural language user input and place desired video content specifications into a structured format. In one example, structured format containing desired video content specifications is JSON. Exemplary JSON of desired video content specifications is shown below.

```
  {
    “brand” : “Spindrift”
    “objectives” : “advertisement”
    “key_message” : “new flavor is good”
    “tone” : “upbeat”
    “duration_sec” : 30
    “platforms” : [“Instagram”, “TikTok”]
}
```

The engine may use machine learning models trained on large datasets of existing scripts to produce storylines and character dialogues. Exemplary datasets of existing scripts may include datasets of structured file formats (e.g., .txt, .JSON) of scripts from successful marketing campaigns, including but not limited to television or streaming service commercials, YouTube shorts, YouTube advertisements, TikToks, Instagram reels, and LinkedIn videos. Exemplary datasets may also comprise collections of high-performing and low-performing video advertisements and short-form social media content (e.g., Instagram Reels, TikToks, YouTube Shorts), annotated with outcome-based performance metrics such as view-through rate, click-through rate (CTR), conversion rate (CVR), completion rate, engagement rate, audience retention curves, brand-lift survey results, and sentiment analysis scores. The output of the natural language processing engine may comprise a structured file comprising a rough script for the desired video content. An exemplary JSON script is shown below.

```
    {
      “script” : {
      “title” : “New Spindrift Flavor”,
      “duration_sec” : 30,
      “beats” :[
        {“time”:0, “type”: “introduction”, “dialogue”: “Quench your thirst this
      summer.....”, “visual” : “close-up of new flavor can”},
        {“time”:12, “type”: “product specifics”, “dialogue”: “The new lemon lime
      flavor....”, “visual” : “two people running on a trail”}
      ]
  }
}
```

The structured script file may specify characters, dialogue, camera angles, set details, audio, animation and more. The natural language processing engine may rely on various subroutines to generate dialogue, refining plot points, or adjusting character development based on user input.

In some embodiments, the natural language processing engine may invoke a plot point refining subroutine that evaluates and adjusts the narrative structure of the structured script file. The structured script file may be represented as a machine-readable hierarchical data structure (e.g., a JSON or JSON-equivalent format) containing a plurality of beats or scene definitions, each specifying at least a timestamp, narrative purpose, dialogue, and visual intent. The inputs of the plot point refining subroutine may comprise one or more of: (i) the current structured script file, including beat timing and narrative arc metadata; (ii) user-specified constraints such as target runtime, platform requirements, tone, or objective (e.g., brand awareness versus direct response); and (iii) historical performance priors or predictive scores derived from previously tested or modeled content. The plot point refining subroutine may parse the structured script file to infer a storyline arc by classifying each beat as belonging to a narrative function such as a “hook,” “problem,” “solution,” “social proof,” or “call to action.” It may then evaluate the clarity, pacing, causal linkage, tension, and payoff readiness of each narrative beat. In some embodiments, the subroutine may utilize a trained ranking or classification model that predicts expected audience retention, emotional engagement, or conversion likelihood for each beat ordering. Where deficiencies are detected (e.g., insufficient setup for conflict, missing resolution, or misaligned pacing), the subroutine may generate one or more candidate revisions. These revisions may include adding, removing, splitting, merging, or reordering beats, and/or modifying narrative emphasis, while preserving the user-defined tone or brand style. The output of the plot point refining subroutine may comprise an updated structured script file, represented as a set of modifications (e.g., updates to a “beats” array, new beat timestamps, or revised dialogue fields), optimized to improve predicted storytelling clarity, engagement, and campaign objective performance.

In some embodiments, the natural language processing engine may further invoke a character development adjusting subroutine that analyzes, evaluates, and modifies the evolution of one or more characters within the structured script file. The structured script file may comprise machine-readable character objects specifying name, persona traits, emotional disposition, goals, relationships, and voice style. The character development adjusting subroutine may parse the script to construct a character state trajectory across beats, inferring each character's goal clarity, agency (e.g., whether the character initiates versus merely reacts), emotional transitions, and relational dynamics. A predictive or rule-based model may be used to compute a character development quality score based on criteria such as narrative motivation clarity, presence of meaningful conflict or internal tension, evidence of progression or reversal, and payoff or resolution consistency with the character's initial objective. In some embodiments, a “good” character development may be defined as exceeding a context-normalized threshold derived from high-performing narrative exemplars in similar genres, formats, or audience segments, whereas a “bad” character development may be defined as failing to present clear motivation, agency, or evolution across the narrative arc. Upon detecting deficiencies, the subroutine may modify the character's dialogue, motivations, decisions, or emotional beats, and may optionally introduce or adjust reversal or growth moments to increase narrative strength. The resulting output may be an updated structured script file containing revised character states and associated beat-level modifications (e.g., altered dialogue lines, updated character goals, or inserted emotional transitions), represented as a set of structured edits that improve character coherence, engagement, and emotional resonance relative to the target objective.

In some embodiments, the natural language processing engine may invoke a dialogue and emotional intelligence (EI) refinement subroutine that evaluates and modifies dialogue segments for emotional resonance, persuasive effectiveness, and audience-appropriate affect. The inputs of the dialogue and emotional intelligence subroutine may comprise one or more of: (i) the structured script file, including beat-level dialogue and inferred character emotional state; (ii) a target audience profile and campaign objective (e.g., comedic, aspirational, authoritative, empathetic, tension-relief, or urgency-driven); and (iii) historical or predictive emotional response data derived from prior campaign outcomes, attention indicia, sentiment trajectories, survey feedback, or physiological proxy signals.

The subroutine may parse the dialogue to detect implicit emotional tone, intent, and valence-arousal properties, and may construct an emotional trajectory map estimating how the viewer's emotional state is likely to evolve at each beat. In some embodiments, a trained model may score each line of dialogue for predicted emotional engagement, authenticity, clarity of motivation, memorability, and alignment with the brand's desired emotional signature. If the subroutine determines that predicted emotional resonance is suboptimal (e.g., the dialogue lacks emotional specificity, fails to build tension or relief, produces unintended emotional dissonance, or does not match the target demographic's motivational profile) the subroutine may generate revised candidate utterances. These may increase empathy, inject contrast or narrative stakes, adjust pacing and semantic rhythm, or optimize emotional impact while preserving factual intent and brand guidelines. In further embodiments, the subroutine may enforce emotional safety constraints by detecting and suppressing language patterns correlated with manipulation risk, cultural insensitivity, or negative emotional dysregulation.

The output of the dialogue and emotional intelligence refinement subroutine may comprise an updated structured script file including revised dialogue lines or annotations (e.g., revised “dialogue,” “mood,” or “emotional_target” fields), represented as a deterministic diff structure, thereby enhancing predicted emotional engagement and conversion outcomes without violating safety, brand, or cultural suitability requirements.

In some cases the natural language processing engine may prompt the user to specify details (e.g., respond to the user within the user input interface with text “Just to clarify if the advertisement is to be posted on Instagram and TikTok, the final product for TikTok should be a .mp4 file with a 9:16 aspect ratio, and for Instagram the final product could be an Instagram Reel meaning a .mp4 file with a 9:16 aspect ratio or an Instagram Feed Video meaning a .mp4 file with a 1:1 or 4:5 aspect ratio. Is this correct?”).

Once the natural language processing engine has generated a script, the script may optionally be further refined using a script refinement module. In some cases, the script refinement module may be activated after the creation of a video content, in other cases it may be activated after the creation of a script. User feedback may inform any changes to the structured script file within the script refinement module. The script refinement module may comprise a separate LLM trained to conform the structured script file based on tone and genre requirements. The script refinement module may be trained on script data labeled based on format of content (e.g., file type, aspect ratio), type of content (e.g., advertisement, entertainment, educational), genre (e.g., comedic, inspiring), success level (e.g., successful, non-successful) and more.

The script refinement module may incorporate feedback loops that allow for iterative improvements. In some cases, the script refinement module may be activated prior to the storyboarding module, parallel with the storyboarding module or after the completion of a first iteration of a piece of video content.

The script from either the natural language processing engine or the script refinement module may be received by a storyboarding module (“storyboard module”). In the context of this application, the term storyboard may be used to describe a sequence of images or drawings which may include directions and or dialogue and may be used to represent visual shots planned for a piece of video content. The storyboard module may utilize the beats (segments) specified in the structured script file to generate individual visual images, each of which may be included in a storyboard representing the desired video content. As previously stated, the beats within the structured script file may include details such as scene composition, camera angles, and lighting which may be helpful in the creation of individual images. To generate individual images contained within the larger storyboard, the storyboard module may deploy image generation tools such as DALL⋅E, Midjourney, Nano Banana, and Unreal Engine. The storyboard created may exist as a .jpeg, .png, .mp4, mov, .pdf, .svg, .json, or other industry-standard visual or structured file format.

After completion of the storyboard, the storyboarding module may display a visual preview of the completed storyboard to the user and prompt the user for feedback on the generated images. For example, the storyboard module may, through the user input interface, display text reading “Here is the completed storyboard for your requested video. Does everything look good?”. In some embodiments, the user may provide feedback which may prompt the activation of the script refinement module.

The storyboarding module may generate a sequence of visual keyframes or scene descriptors representing the intended camera perspective, subject composition, emotional tone, spatial layout, and approximate timing for each beat of the narrative. The storyboarding module inputs may comprise one or more of: (i) the refined structured script file including updated beat structure, dialogue, emotional intent, and character metadata; (ii) target platform or aspect ratio constraints (e.g., 9:16 for TikTok or Instagram Reels, 16:9 for connected TV); and (iii) brand or stylistic guidelines specifying visual tone, palette constraints, or cinematic conventions. The storyboarding module may parse each beat to infer one or more visual elements such as framing (e.g., wide shot, medium shot, close-up), subject count, camera movement, and environmental context, and may further incorporate emotional alignment by selecting visual metaphors or composition strategies (e.g., closer facial framing to amplify empathy or tension, wider framing to imply freedom or vulnerability). In certain embodiments, the storyboarding module may utilize a trained generative model (e.g., an image diffusion model or a 3D scene sketch generator) to output provisional visual renderings or textual scene descriptors encoded in a machine-readable format (e.g., JSON or equivalent), where each storyboard panel may specify fields such as “visual_prompt,” “camera_angle,” “lighting_style,” “character_pose,” and “mood_signal.” The resulting storyboard output may be deterministic or sampling-driven, and may optionally include confidence or alignment scores indicating the predicted emotional or narrative coherence of each generated frame. The storyboard output may be presented to a user for optional review or passed automatically to downstream modules such as pre-production planning or virtual component generation.

In some embodiments, the structured script file and storyboard output may be provided to a pre-production planning module configured to automatically generate production logistics, including scheduling, budgeting, resource allocation, and casting recommendations. The inputs to the pre-production planning module may comprise one or more of: (i) the refined structured script file, including character definitions, duration, emotional intention, and target platform specifications; (ii) the storyboard data, including camera angle, visual complexity, and scene-level mood attributes; and (iii) user-specified constraints such as budget ceilings, permissible shooting environments, or brand-mandated visual tone. The module may analyze each beat and scene to determine required virtual or physical resources, including actor profiles (e.g., demographic attributes, emotional range, voice tone), environment requirements (e.g., interior, exterior, product demo environment), and motion or animation complexity. In certain embodiments, the module may calculate an estimated production cost and timeline by referencing a trained predictive model derived from historical production data, taking into account scene complexity, number of characters, and required effects. The pre-production planning module may output a machine-readable production plan (e.g., in JSON or JSON-equivalent format) specifying, for each scene or beat, casting recommendations, asset requirements, scheduling order, estimated time allocation, and budget breakdown. In some embodiments, the production plan may further incorporate emotional optimization (e.g., associating specific character casting or performance direction with emotional tone targets derived from prior subroutines) thereby ensuring alignment between narrative intent and execution logistics from the earliest planning stage.

Using the storyboard, and production plan a virtual component production module may coordinate and deploy generative AI models to create and virtual video content components (“virtual components”). Virtual video content components may include but are not limited to virtual environments, sets, and actors, audio, and objects. The virtual component production module may parse the storyboard to determine the number and specifics of virtual components required for each portion of the script.

The inputs of the virtual component production module may comprise one or more of: (i) the revised script and emotional intent annotations; (ii) the storyboard data including camera angle, lighting mood, and scene composition descriptors; and (iii) the production plan specifying casting recommendations, asset requirements, and budget or complexity constraints. The module may utilize one or more generative AI models (e.g., image diffusion models, 3D scene generation engines, or neural asset synthesis pipelines) to generate provisional or fully-rendered virtual components. In one embodiment, virtual components may be generated by a generative AI such as the Unreal Engine and/or ComfyUI. These virtual components may be stored in a machine-readable asset format (e.g., GLB, .GLTF, FBX, .OBJ, .USD, USDZ, or equivalent) and may each include metadata describing spatial orientation, emotional tone, animation affordances, or brand-consistency settings. The virtual component production module may further apply emotional intelligence constraints to ensure that each character or environmental asset visually expresses or supports the emotional trajectory determined by the preceding subroutines. In certain embodiments, the module may rank multiple candidate asset variants and retain the one predicted to optimize engagement, brand alignment, or storytelling coherence.

Subsequently, the generated virtual components may be passed to a virtual component animation module. The virtual component animation module may generate temporal sequences by applying motion-capture data, procedural animation curves, or generative motion models to animate characters and objects in synchronization with the script, storyboard timing, and emotional beat targets. The animation output may be represented as a video sequence or intermediate scene graph in a machine-readable format (e.g., .mp4, .mov, .usda, or equivalent).

Examples of software that may be used by the virtual component animation module to animate the previously generated virtual components include but are not limited to Unreal Engine, Unity, Blender, Autodesk Maya, ComfyUI, or other AI-assisted or physics-based animation engines.

In some embodiments, the animated video sequence generated by the virtual component animation module may be provided to a post-production refinement module configured to apply visual, auditory, and narrative polish prior to final output.

The inputs of the post-production refinement module may comprise one or more of: (i) the intermediate video content file, including scene timing and emotional annotations; (ii) the structured script file, including finalized dialogue and target emotional trajectory; and (iii) platform-specific or brand-specific delivery requirements (e.g., legal disclaimers, audio loudness thresholds, text legibility rules, or logo-treatment requirements). The module may apply one or more enhancement subroutines, including color grading, visual effects compositing, simulated depth-of-field adjustments, audio mixing, music insertion, and final voiceover alignment. In some embodiments, the module may utilize pretrained generative models (e.g., speech-to-speech refinement, auto-mixing engines, or AI-driven color models) to automatically optimize emotional tone, clarity of messaging, and persuasive pacing. The module may further predict post-production emotional alignment by evaluating whether the audiovisual output at each beat reinforces the intended emotional cue (e.g., uplift, urgency, humor, tension release) and may revise audio or visual elements if a divergence from the desired emotional or commercial effect is detected.

The output of the post-production refinement module may be a finalized video asset in one or more target file formats (e.g., .mp4, .mov, .avi, or equivalent), as well as a structured metadata file describing the emotional curve, brand-safety status, and compliance alignment of the generated content.

In the context of this application, the term “generative artificial intelligence orchestration layer” or “generative AI orchestration layer” may be used to refer the natural language processing engine, the script refinement module, the storyboarding module, the pre-production planning module, the virtual component production module and the virtual component animation module collectively.

As previously stated, the necessary elements of the invention include the user input interface, natural language processing (NLP) engine, storyboard module, pre-production planning module, virtual component production module, virtual component animation module and post-production module. However, in some embodiments the invention may additionally comprise a market testing module and a distribution module.

In some embodiments, the finalized or near-final video content may be provided to a market testing module configured to simulate or predict audience response prior to real-world deployment.

The inputs of the market testing module may comprise: (i) the generated video asset and its associated emotional and narrative metadata; (ii) a user-specified target audience definition, including demographic, psychographic, geographic, behavioral, or contextual attributes; and (iii) historical or predictive performance signals derived from prior campaign data or simulated environment models. The module may evaluate the content using one or more predictive subroutines, such as attention-retention modeling, sentiment trajectory analysis, likely click-through or conversion estimation, brand lift forecasting, or projected emotional impact curves over time. In certain embodiments, the market testing module may conduct multi-variant evaluation, optionally generating hypothetical or synthetic feedback samples using trained simulation models. In some cases, the module may run tests to simulate audience reaction for several different market demographics. Target audience demographic may be specified by the user via natural language within the user input interface. Target audience demographic may include specifications of age, location, education, interests, job and more. In other embodiments, different versions of the generated video content may be tested to optimize the video content for a specific audience demographic. The module may produce comparative performance scores or rankings across audience segments, delivery platforms, or emotional framing strategies. If predicted performance for a specified objective falls below a target threshold, the module may generate structured recommendations for revision (e.g., strengthening the call to action, adjusting emotional escalation timing, or refining visual emphasis) and may optionally trigger one or more upstream refinement subroutines to automatically update the structured script file, storyboard, or animation parameters.

The market testing output may include a structured metadata file specifying predicted performance metrics, confidence intervals, and recommended modifications to improve alignment with the user's target objective. Market-testing module performance metrics may include but are not limited to engagement metrics (e.g., view count, watch time, click-through rate), conversion metrics (e.g., expected sign up rate, purchase likelihood, download rate), sentiment metrics (e.g., predicted sentiment score, positive, neutral, negative), retention metrics (e.g., completion rate, rewatch probability) and demographic segmentation metrics (e.g., predicted engagement metrics by age, gender or interest cluster). Predictive audience response

In some embodiments, the finalized video content and associated performance predictions from the market testing module may be provided to a distribution optimization module configured to determine the optimal release strategy for the generated content.

The inputs of the distribution optimization module may comprise: (i) the refined video asset; (ii) predicted or simulated performance signals for one or more audience segments or platform types; and (iii) user-specified or system-inferred objectives such as maximum reach, highest conversion rate, cost efficiency, or viewer retention. The module may analyze relevant contextual factors, including target audience availability windows, current or forecasted platform traffic conditions, campaign frequency caps, cultural timing sensitivity, or competitive saturation estimates. In some embodiments, the distribution optimization module may utilize predictive scheduling or reinforcement learning policies to generate a distribution plan specifying which version of the content (e.g., if multiple variants exist), at what time, on which delivery platform, and to which specific audience segment the content should be released.

The distribution plan may be output as a machine-readable set of instructions that may be executed either automatically by the system or provided to a user for manual deployment. In further embodiments, the module may continuously monitor real-time performance data once the content is deployed and may dynamically adapt or reorder subsequent distribution decisions (e.g., shifting platform priority or audience weighting in response to actual observed attention or conversion data).

In some embodiments, once the video content has been deployed to one or more distribution channels, a post-distribution performance analytics module may be invoked to track real-world audience engagement and outcome metrics.

The inputs of the post-distribution performance analytics module may comprise: (i) observed behavioral interaction data (e.g., view-through rate, click-through rate, dwell time, save/share rates, conversion rate, or brand lift deltas), (ii) sentiment or qualitative indicators (e.g., comment analysis, reaction-type breakdown, cultural resonance signals), and (iii) platform-delivered attention or incrementality estimates where available. The module may compare observed performance against predicted performance generated by the market testing module and may compute a performance deviation score for each beat, emotional moment, or call to action within the generated content.

In certain embodiments, these observations may be used to automatically update, fine-tune, or re-weight one or more upstream subroutines (e.g., improving future dialogue generation accuracy, emotional cue alignment, or audience targeting precision). In further embodiments, the post-distribution performance analytics module may produce a structured feedback dataset that may be stored within a reinforcement or continual learning framework, thereby enabling the system to iteratively improve future content generation, testing, and distribution cycles based on live market behavior. The module may additionally generate an optional briefing for the user summarizing the content's performance, including recommended next actions such as scaling winning variants, refreshing creative for retention decay, or re-targeting high-performing segments.

In some embodiments, the system may incorporate an emotional intelligence (EI) orchestration layer that operates across multiple subroutines (e.g., the script generation module, character development, dialogue refinement, storyboarding module, virtual component production module, virtual component animation module, post-production refinement module, market testing module, and distribution optimization module) to ensure that emotional resonance is continuously optimized and contextually appropriate throughout the content lifecycle. The emotional intelligence orchestration layer may track an emotional state model representing predicted viewer affect and engagement level at each beat and may enforce cross-module consistency by detecting emotional discontinuities (e.g., abrupt tonal breaks, insufficient narrative payoff, or misaligned musical or visual effect) and triggering upstream or downstream adjustments. In certain embodiments, the emotional-intelligence orchestration layer may enforce both performance-oriented objectives (e.g., maximizing predicted engagement, persuasion, or retention) and safety-oriented constraints (e.g., avoiding emotionally manipulative sequences, culturally insensitive portrayals, or harmful psychological triggers). The orchestration layer may therefore function as a supervisory process, ensuring that emotional quality is neither incidental nor fixed at a single stage, but rather dynamically calibrated and preserved across the entire generative pipeline, from inception through distribution and feedback-based iteration.

In certain embodiments, the emotional intelligence orchestration layer may comprise an emotional-intelligence module (“EI module”) configured to infer and operationalize affective signals for creative decisioning.

The inputs of emotional-intelligence module may comprise one or more of the following: (i) the structured script file and associated metadata (e.g., beat timing, tone, intent), (ii) storyboard frames or proxy renders, (iii) audience-segment descriptors (e.g., age, interests, psychographics), and (iv) historical performance records. Using one or more trained models (e.g., multimodal transformers, affect classifiers), the emotional-intelligence module may generate per-beat and per-asset affect vectors that quantify predicted emotional responses (e.g., arousal, valence, discrete emotions such as anticipation or joy) and attention-persistence likelihoods.

In the context of this application, the term “affect vector” may be used to refer to a machine-readable representation (e.g., an array) encoding predicted emotional and/or attentional attributes for a content unit (e.g., beat, frame, shot), including one or more of valence, arousal, discrete emotion scores, and attention-persistence likelihood.

The outputs of the emotional-intelligence module may comprise machine-readable guidance, such as (a) weights applied to narrative variables (e.g., pacing, reveal order, character expression), (b) camera and lighting adjustments, and (c) selection or substitution scores for alternative scenes or voice over (“VO”) takes. In some embodiments, the emotional-intelligence module provides a closed-loop interface to the script-refinement, storyboarding, virtual-component production, and post-production modules, enabling automated or semi-automated revision of content elements to target a specified emotional profile for a given audience segment. In other embodiments, the emotional-intelligence module may calibrates its predictions using A/B or multivariate tests performed by the market-testing module, thereby updating affect-to-outcome mappings and improving downstream creative recommendations over time. The emotional-intelligence module may also enforce guardrails (e.g., bias and sensitivity checks) by constraining recommendations to comply with policy rules specified by the user or an enterprise policy engine.

Furthermore, in some embodiments, the invention may comprise collaboration environment, which enhances team productivity with real-time collaboration of video content.

Although the foregoing description illustrates specific modules, subroutines, data flows, and operational sequences, it should be understood that the invention is not limited to the particular ordering, labeling, or functional subdivision presented herein. The various components of the system may be combined, omitted, reorganized, executed concurrently, iteratively, or distributed across distinct computing entities without departing from the scope of the invention. Any of the subcomponents described above may be implemented using software, firmware, hardware, or any combination thereof.

Furthermore, the techniques disclosed herein are not limited to a single content genre, vertical, or media format, and may be applied to advertising, entertainment, educational, industrial, narrative, or interactive content, as well as to emerging content modalities including augmented reality, virtual reality, mixed-reality, holographic, and synthetic media environments. The embodiments described above are provided for the purpose of clarity and illustration; variations, substitutions, extensions, or omissions that would be apparent to a person of ordinary skill in the art, in view of the present disclosure, are intended to fall within the scope of the appended claims.

It will be understood that references in the foregoing description to specific technologies, such as large language models (LLMs), diffusion-based image generators, motion-generation models, or structured data formats such as JSON, are provided solely for illustrative purposes and are not intended to limit the invention to any particular vendor, architecture, neural model family, training paradigm, deployment environment, data schema, or programming stack. Any function described herein may be implemented using any suitable artificial intelligence model, heuristic engine, rule system, or hybrid thereof, including but not limited to transformer-based models, recurrent neural networks, graph neural networks, generative adversarial networks, diffusion models, reinforcement learning systems, symbolic-AI pipelines, or future architectures not yet developed. Similarly, any “file,” “object,” “instruction,” or “representation” described herein may exist in ephemeral form, non-transitory memory, compiled embedding space, or dynamically computed process state. Accordingly, the scope of the invention should not be construed as restricted to any specific technical implementation unless expressly recited in the claims.

The components and steps of the disclosed system and method may be rearranged or interchanged to maintain similar functionality. In some embodiments the script refinement module may be called prior to the script generation module, after the script generation module, or after the storyboarding module. Similarly, in some embodiments, the pre-production module may be called before the storyboarding module.

For the following description, it can be assumed that most correspondingly labeled elements across the figures (e.g., 105 and 205, etc.) possess the same characteristics and are subject to the same structure and function. If there is a difference between correspondingly labeled elements that is not pointed out, and this difference results in a non-corresponding structure or function of an element for a particular embodiment, example or aspect, then the conflicting description given for that particular embodiment, example or aspect shall govern.

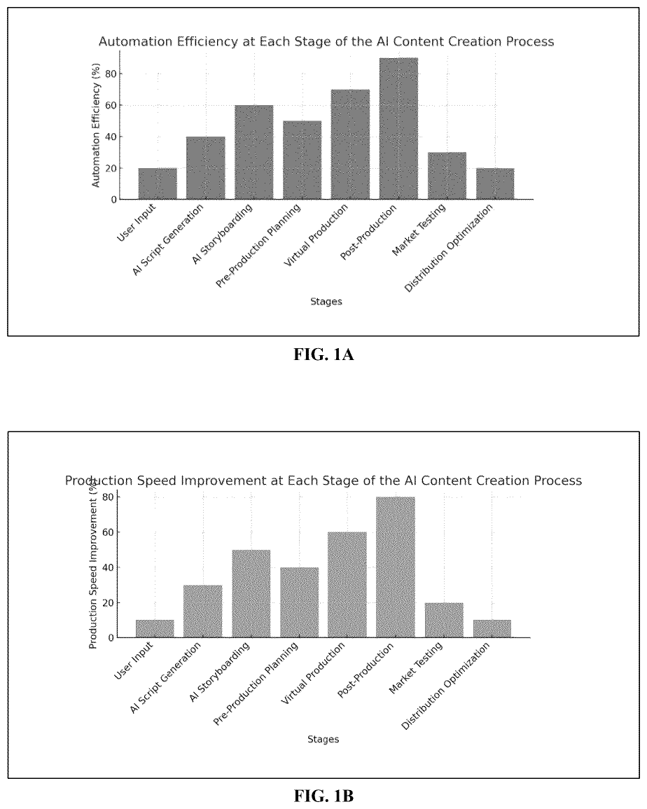

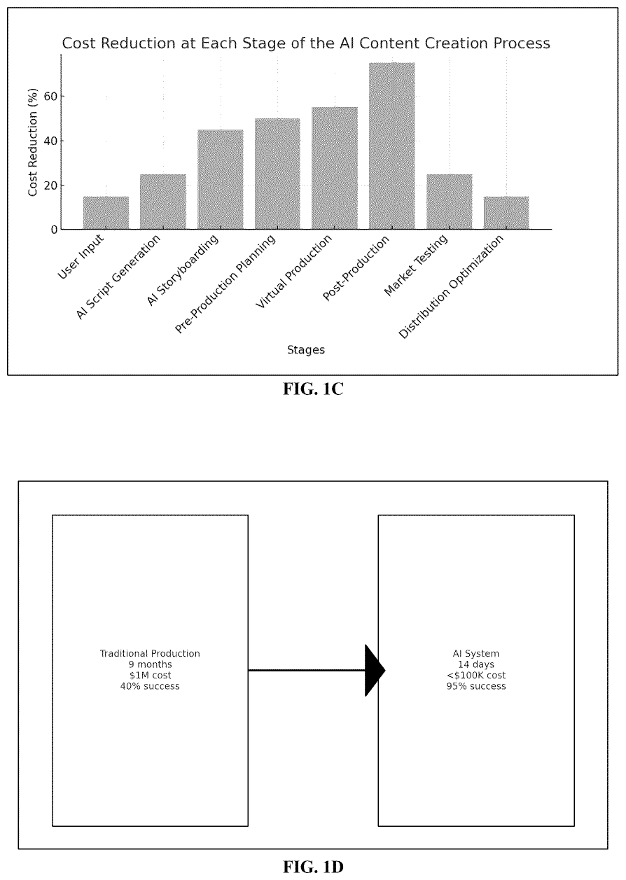

FIGS. 1A-D illustrates charts of performance metric improvements at each stage of the content creation process, associated with use of the disclosed invention. The data shown in FIGS. 1A-D is for illustrative purposes and does not represent empirical third-party data.

FIG. 1A depicts a chart showing the believed automation efficiency at each stage of the content creation process. In the context of this application, the phrase automation efficiency may be used to refer to the proportion of production tasks that may be completed by a system and method for generating video content using natural language. An automation efficiency of zero (0%) would indicate that the entire process is required to be performed manually. An automation efficiency of 1 (100%) would indicate that the entire process could be performed by a system and method for generating video content using natural language. As shown, the user input stage of the content creation process is believed to have an automation efficiency of 20% meaning that 20% of the user input stage may be completed by a system and method for generating video content using natural language. It is believed that the script generation stage has an automation efficiency of 40%. It is believed that the storyboarding stage has an automation efficiency of 60%. It is believed that the pre-production planning stage has an automation efficiency of 50%. It is believed that the virtual production stage (e.g., virtual component production, virtual component animation) has an automation efficiency of 50%. It is believed that the post-production stage has an automation efficiency of 90%. It is believed that the market testing stage has an automation efficiency of 30%. Lastly, it is believed that the distribution optimization stage has an automation efficiency of 20%.

FIG. 1B depicts a chart showing the believed production speed improvement at each stage of the content creation process. It is believed that the user input stage has a production speed improvement of 10%. It is believed that the script generation stage has a production speed improvement of 30%. It is believed that the storyboarding stage has a production speed improvement of 50%. It is believed that the pre-production planning stage has a production speed improvement of 40%. It is believed that the virtual production (e.g., virtual component production, virtual component animation) stage has a production speed improvement of 60%. It is believed that the post-production stage has a production speed improvement of 80%. It is believed that the market testing stage has a production speed improvement of 20%. It is believed that the distribution optimization stage has a production speed improvement of 10%.

FIG. 1C depicts a chart showing the believed cost reduction at each stage of the content creation process. It is believed that the user input stage has a cost reduction of 15%. It is believed that the script generation stage has a cost reduction of 25%. It is believed that the storyboarding stage has a cost reduction of 45%. It is believed that the pre-production planning stage has a cost reduction of 50%. It is believed that the virtual production (e.g., virtual component production, virtual component animation) stage has a cost reduction of 55%. It is believed that the post-production stage has a cost reduction of 75%. It is believed that the market testing stage has a cost reduction of 25%. It is believed that the distribution optimization stage has a cost reduction of 15%.

FIG. 1D depicts a comparison of the time, cost, and success rate of traditional content creation process vs. a content creation process augmented by a system and method for generating video content using natural language. It is believed that typical content creation (production) methods would result in a content creation timeline of nine months to distribution. It is believed that the content creation process using traditional methods would cost roughly one million USD. Furthermore, it is believed that the piece of content generated via conventional methods would have a worse success rate. The foregoing values are representative of a commercial advertising campaign comprising a single or limited series of video advertisements intended for digital or televised distribution; however, similar proportional improvements may be observed for episodic, educational, or long-form narrative content.

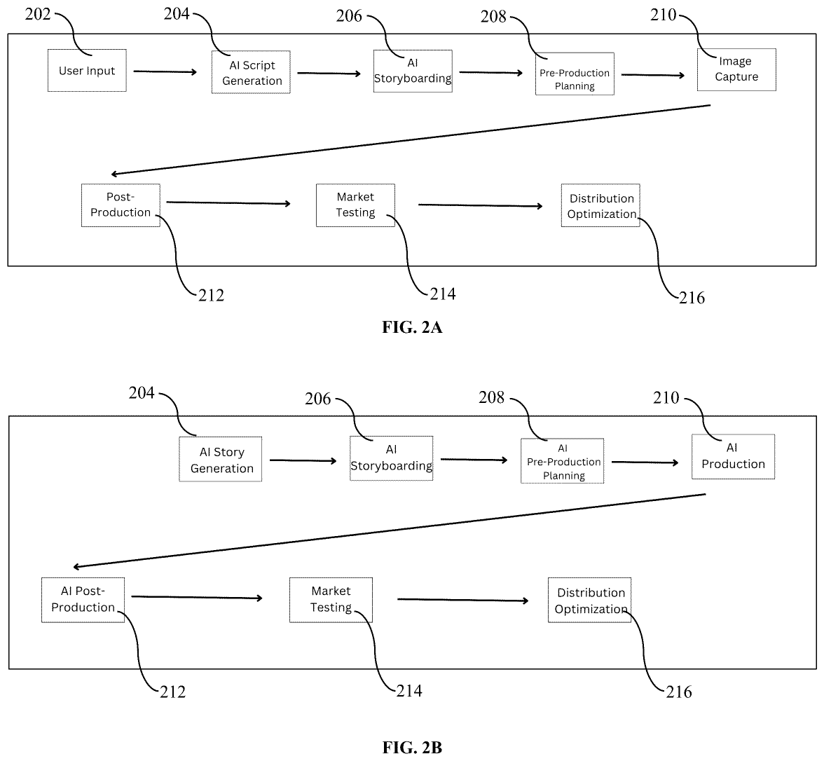

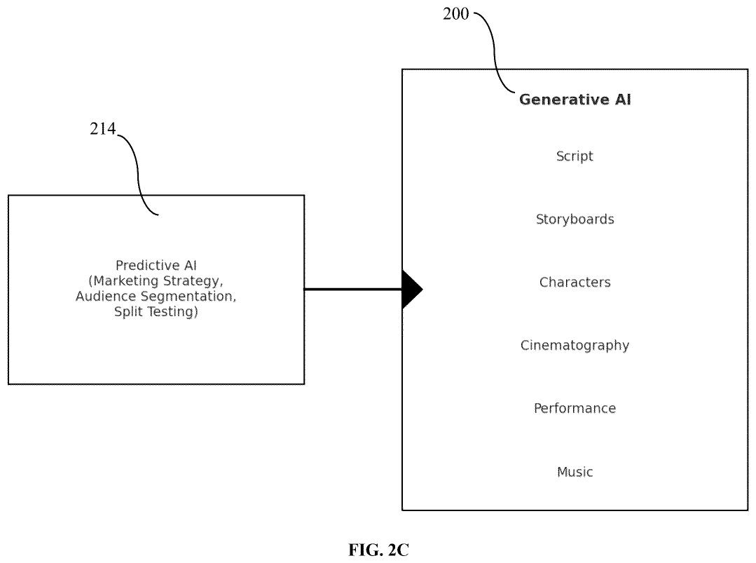

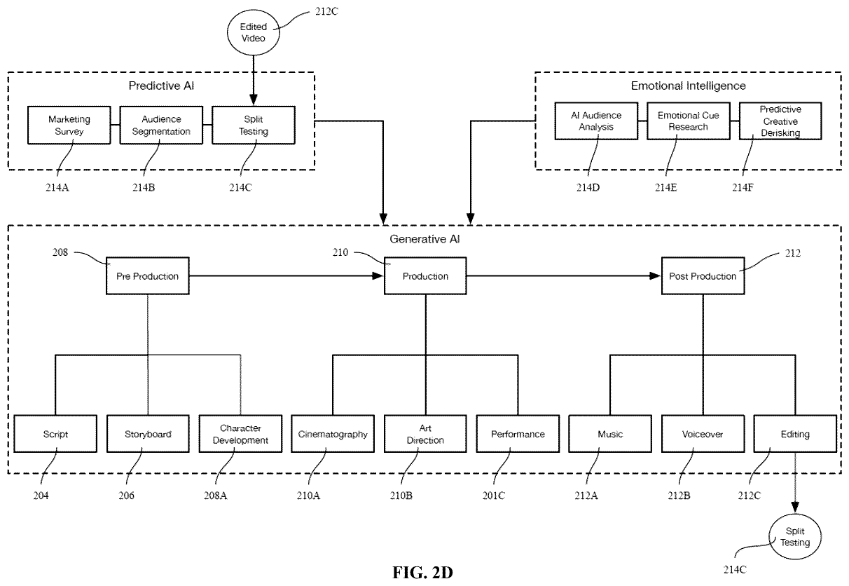

FIGS. 2A-D each illustrate a flowchart or block diagram of a rough process flow of a system and method for generating video content using natural language, according to an aspect.

FIG. 2A depicts a flowchart of a rough (high-level) process flow of a system and method for generating video content using natural language, according to an aspect. As shown, the process may begin, at step 202, with user input in the form of natural language which may be supplied via a user input interface. At step 204, the user input interface may contact a natural language processing (NLP) engine which may parse the user input to determine desired content attributes to generate a structured script file. The structured script file may then be used by a storyboarding module, at step 206, to generate a storyboard. At 208, both the script and storyboard may be processed by a pre-production planning module which may consider budget and time requirements to produce a production plan. The script, storyboard and production plan may all be utilized by both a virtual component production module and a virtual component animation module, labeled as image capture 210 in FIG. 2A. These modules may work to produce a video content file which may be further refined by a post-production module at step 212. Subsequently, at 214, a market testing module may be called to simulate audience reactions to the generated video content. Lastly, at 216, a distribution optimization module may be called and generate a distribution plan for the generated content. A distribution plan may comprise suggested release time(s) and platforms.

FIG. 2B similarly depicts a flowchart of a rough (high-level) process flow of a system and method for generating video content using natural language, according to an aspect. As shown, the process may begin with 204 AI story generation which may comprise receiving user input through a user input interface, processing such input via a natural language processing engine, generating a structured script file, and refining the script file. Step 206 denotes generating a storyboard file based off the structured script file from 204, and step 208 refers to the use of the pre-production planning module. At step 210, a virtual component production module and a virtual component animation module may be used to generate a piece of video content based off of the structured script file, storyboard, and production plan. Subsequently, at 212, post-production activities including the use of a post-production module may be used to further refine the video content file. As previously referenced, market testing may occur at step 214 and distribution optimization at step 216.

FIG. 2C depicts a flowchart of a rough (high-level) process flow of a system and method for generating video content using natural language, according to an aspect. As shown, in some embodiments the system and method for generating video content using natural language may begin with a marketing strategy determination to guide the content creation process. In some cases, marketing strategy determination may be performed by a predictive artificial intelligence module. In some embodiments, the marketing strategy determination may be implemented as a module or subroutine that aggregates and evaluates contextual data prior to content generation. Such data may include historical campaign performance, current market trend signals, audience sentiment intelligence, platform-specific engagement forecasts, or real-time competitive activity. The system may extract or infer this data via API integrations, pre-indexed knowledge graphs, or proprietary performance datasets. The predictive artificial intelligence module may then generate a structured strategy object comprising elements such as target audience profile, platform priority, narrative tone constraints, recommended duration, emotional persuasion objectives, and ranked distribution channels. A marketing strategy determination may comprise a target audience, a distribution channel, one or more desired content attributes which may be incorporated into the structured script file. The market strategy may inform the subsequent video content creation at step 200. Step 200, representing the video content creation process, may comprise aforementioned steps 202, 204, 206, 208, 210 and 212.

FIG. 2D depicts a flowchart of a rough (high-level) process flow of a system and method for generating video content using natural language, according to an aspect. As previously stated, in some cases the system and method for generating video content using natural language may begin by using a market testing module to generate a marketing strategy determination which may inform the subsequent video content creation process. As shown, a market testing module may comprise several subroutines, including but not limited to market testing 214A, audience segmentation 214B, split testing 214C, audience analysis 214D, emotional cue research 214E, and predictive creative derisking 214F. Market testing 214A may analyze historic and live performance data from prior video campaigns to identify variables such as message resonance, optimal call-to-action phrasing, and engagement duration thresholds.

Audience segmentation 214B may classify users into clusters based on demographic, psychographic, and behavioral indicators extracted from audience datasets, CRM records, or third-party data providers.

Split testing module 214C (“split-testing and performance feedback module”, “performance feedback module”) may generate and compare multiple variations of proposed content elements (e.g., titles, thumbnails, color schemes, or taglines) to determine which version yields higher predicted engagement metrics such as click-through rate or completion rate. The split testing module may be utilized to enable continuous optimization of generated video content.

As used herein, the term “split testing” or “A/B testing” may be used to refer to a process by which two or more variants of a creative asset are simultaneously distributed to statistically equivalent audience segments. Performance metrics for each variant are collected and analyzed to determine which version produces superior engagement, recall or conversion results. The variants of a creative asset may differ in one or more variables such as script structure, imagery, tone, music selection or call-to-action.

The split testing module may deploy distinctive creative variants generated by the virtual component production module to different digital endpoints (e.g., different social media platforms, content platforms such as YouTube or Spotify, email lists, news outlets or blogs). Each variant may be tagged with a unique identifier and metadata describing the creative attributes, target audience parameters, and intended emotional profile. Analytics such as attention duration, click-through rate, dwell time and completion percentage may be captured via integrated application programming interfaces (APIs) from CTV, social and programmatic ad networks.

The split testing module may aggregate the aforementioned data and perform regressions and reinforcement learning analysis to infer the relative contribution of each creative element to overall content performance. The split testing module may generate predictive performance weights that are then used to inform subsequent content generation cycles.

The split testing module may be used within a broader feedback loop comprising content generation, content distribution and/or content testing, and performance analysis. After each iteration, the system may refine its representations of high performing content attributes (e.g., , tone, pacing, visual composition) thereby enabling

The data gathered by the split testing module may additionally update a database, allowing the model to learn across campaigns and clients. As a result, each use and content deployment may strengthen the predictive capacity of the underlying content generation modules (e.g., natural language processing engine which generates a structured script file, script refinement module, storyboarding module, pre-production planning module, virtual component production module and virtual component animation module).

Audience analysis 214D may employ natural-language and computer-vision analytics to detect dominant themes, brand sentiment, and visual style preferences among target viewers, producing an “audience insights vector” that encodes preferences in quantitative form. In the context of this application the term “computer-vision analytics” may be used to describe Emotional cue research 214E may leverage multimodal emotion recognition datasets to identify which affective triggers (e.g., humor, nostalgia, tension, empathy) produce the strongest expected viewer response for a given audience segment.

Additionally, predictive creative derisking 214F may apply reinforcement learning or regression models to forecast the relative success probability of different narrative or visual strategies, enabling the system to prioritize those most likely to achieve campaign objectives.

The collective outputs of these subroutines may be synthesized into a marketing strategy determination object, which may define key parameters such as target audience profile, emotional tone, recommended creative style, preferred runtime, and optimal distribution channels. This object may then feed into downstream modules for structured script generation, storyboard creation, and content refinement. Each of the aforementioned subroutines may pass their respective outputs to the market testing module, which may, as previously mentioned, generate a marketing strategy determination which may inform subsequent video content creation efforts.

Video content creation may, broadly speaking, comprise three stages, including pre-production 208, production 210 and post-production 212. Each of the three stages may be thought of as a subsystem or collection of steps within the system and method for generating video content using natural language.

Pre-production 208 may, in some cases, be used to refer to the steps leading to the generation of a script, storyboard and production plan. In other cases, step 208 may refer to only the generation of a production plan. As shown in FIG. 2D, pre-production 208 refers to steps or subroutines that lead to the creation of a script, storyboard, and production plan.

Pre-production 208 may comprise script module 204. Script 204 may utilize a natural language processing engine to parse user input from a user input interface in order to determine desired content characteristics that guide the creation of a structured script file. Script 204 may also comprise a script refinement module which may take subsequent user input further edit the script file.

The script file from script 204 may be used to create a storyboard at storyboard 206. Both the script of 204 and storyboard of 206 may inform the production plan to be generated at pre-production 208.

Pre-production 208 may additionally comprise character development module 208A. In some embodiments, the inputs to character development module 208A may comprise: (i) the structured script file produced by 204, including character objects (name, role, goals, obstacles, relationships, voice attributes) and beat-level placements; (ii) the storyboard descriptors from 206 (e.g., framing, focal subject, emotional tone per beat); and (iii) strategy constraints emitted by the marketing strategy determination (e.g., target audience profile, tone and reading level, inclusivity requirements, desired emotional trajectory). Character development module 208A may construct a character state graph (CSG) in which nodes represent per-beat character states and edges represent decisions, actions, or conflicts affecting those states. Using the character state graph, character development module 208A may compute trajectory features including goal clarity, agency ratio (e.g., initiated vs. reactive actions), growth/change across the arc, consistency of voice, relationship dynamics, and payoff alignment to initial wants/needs. A trained scoring model may produce a character development score (CDS) for each principal character, normalized by genre, format, and audience segment. When the character development score for a character falls below a threshold, character development module 208A may generate revision candidates that (a) clarify want/need early in the arc, (b) introduce or strengthen internal/external conflict, (c) insert a reversal or midpoint decision to increase agency, (d) align dialogue timbre and reading level to the audience specification, and/or (e) adjust beat timing to improve emotional payoff prior to the call-to-action.

Selected revisions may be emitted as a series of updates to the structured script file (e.g., additions or modifications to character goals, beat annotations, and dialogue lines) and as optional notes to the storyboard (e.g., adjust framing to emphasize protagonist agency). In some embodiments, character development module 208A may also enforce brand-safety and inclusion guardrails by detecting stereotypical portrayals or tone mismatches and proposing compliant alternatives. The outputs of 208A may therefore comprise: (i) an updated script JSON with revised character metadata and beat-aligned dialogue; (ii) a machine-readable diff describing the specific edits; and (iii) per-character character development score values and rationales, which are consumed by scheduling/budgeting logic within pre-production 208 to prioritize scenes with the greatest predicted impact on narrative and commercial objectives.

The production plan produced by pre-production 208 may inform the production steps of 210. Production 210 may comprise cinematography 210A, art direction 210B and performance 210C. At the conclusion of production 210, a video content file may be produced. The produced video content file of 210 may be further refined by post-production steps 212. Post-production steps 212 may comprise music 212A, voiceover 212B and editing 212C.

Music 212A may be a module or subroutine which may add background music or audio effects to video content generated by production steps 210. In some embodiments, Music 212A may derive its selections from both (i) user-provided directives (e.g., “cinematic and inspirational,” “dark and aggressive,” “90s hip-hop,” “family-friendly and upbeat”) extracted from the natural-language user input, and (ii) the emotional tone and pacing constraints specified within the marketing strategy determination object. The module may query an indexed library of pre-licensed musical stems, adaptive soundtrack templates, or generative audio models, each tagged with metadata such as tempo range, emotional valence (e.g., uplifting, tense, nostalgic), cultural appropriateness, instrumentation type, and brand safety level. Music 212A may compute an emotional and rhythmic alignment score between each candidate asset and per-beat script annotations (e.g., rising tension, comedic release, empathetic reflection) or storyboard states. In some cases, it may further adjust tempo, intensity, or layering in real time using dynamic mixing rules to ensure synchronization with key visual or narrative beats. The selected music cue or adaptive composition may then be applied as a background track and, in certain embodiments, its parameters remain editable if later creative derisking or performance forecasting suggests a mismatch.

Voiceover 212B may add voiceover audio to the video content generated by production steps 210. In some embodiments, voiceover 212B may determine what voiceover audio to generate or apply based on (i) the narrative tone, target audience profile, and emotional intent specified in the marketing strategy determination object, and (ii) per-beat dialogue annotations or character metadata contained within the structured script file. The module may access a library of pre-trained synthetic voices, cloned voices, or adaptive text-to-speech models, each annotated with attributes such as gender presentation, age range, accent, energy level, pacing characteristics, emotional valence (e.g., authoritative, empathetic, humorous), and cultural or brand safety ratings. Voiceover 212B may compute an alignment score between these voice attributes and the audience segment or emotional delivery requirements for each scene or beat. In some cases, the module may automatically adjust speech rate, intonation, or prosodic emphasis to synchronize with musical tempo or anticipated viewer attention peaks. If multiple viable candidates score above a threshold, the module may either select the highest-scoring option autonomously or request user confirmation. The selected voiceover may then be rendered, optionally fine-tuned for lip-sync or emotional pacing, and layered onto the video timeline during post-production. In some cases, music 212A may add background music to the video file prior to voiceover 212B adding voiceover audio, in other cases the order is reversed.

Additionally, editing 212C may add further visual effects to the video content generated in production steps 210. In some embodiments, editing 212C may determine which visual or timing effects to apply by first analyzing the beat-level emotional annotations, pacing requirements, and visual style preferences embedded in the structured script file, storyboard metadata, and marketing strategy determination object. The module may process video timing cues, such as scene tension rise, comedic release, or call-to-action emphasis, and match them against a library of editing templates or effect rules tagged with attributes such as transition style (e.g., hard cut, cinematic dissolve, kinetic whip-pan), intensity, color mood, motion emphasis, or expected viewer attention retention. Editing 212C may compute an alignment score between each potential edit or effect and predicted audience engagement curves generated by the market testing or predictive creative derisking subroutines. For example, if the strategy indicates a fast-paced, high-energy delivery aimed at a youth demographic, the module may automatically apply jump cuts or motion-accentuating effects, whereas a cinematic or emotional narrative may trigger smoother transitions, lens flares, or color grading optimized for warmth or nostalgia. In certain embodiments, editing 212C may further re-time or re-sync the visual sequence to match approved music or voiceover cadence, dynamically adjusting the beat structure to preserve emotional coherence and maximize projected engagement or retention.

As previously stated, in some cases, at the completion of post-production steps 212, the system and method for generating video content using natural language may call a market testing module and/or a distribution optimization module.

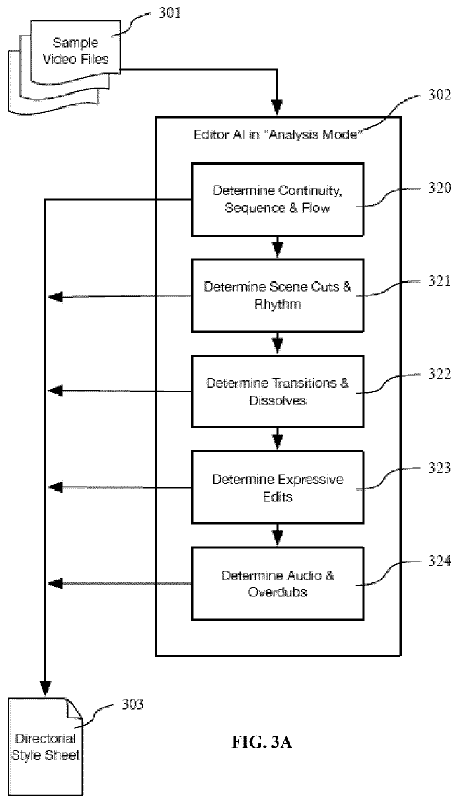

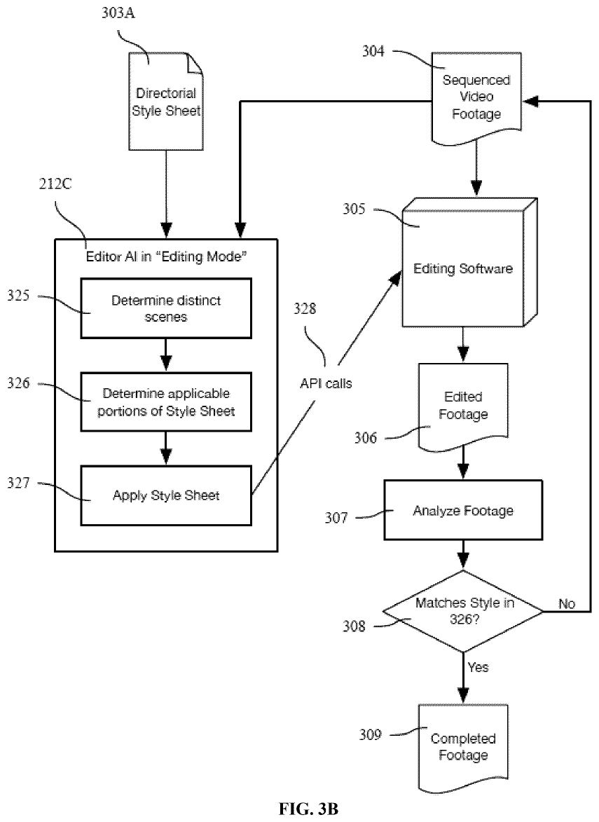

FIGS. 3A-B each depict flow charts of portions of the video content editing process withing a system and method for generating video content using natural language, according to an aspect.

FIG. 3A depicts a flow chart of the creation of a directorial style sheet. Editing module 302, which in some cases may be similar to aforementioned editing 212C, may be used to generate directorial style sheet 303. The input to editing module 302 may comprise sample video files 301. Editing module 302 may comprise several subcomponents or submodules including but not limited to narrative flow submodule 320, scene determination submodule 321, scene transition submodule 322, expressive edits submodule 323 and audio and overdubs module 324. Narrative flow submodule 320 may be used to generate an overarching narrative for a structured script file based on user input. An exemplary overarching narrative may, in the case of a sporting goods advertisement, be “Children learning the values of hard work and sportsmanship through adversity”. In some cases, when video input is provided narrative flow submodule 320 may be used to ascertain video continuity and narrative flow of the shots, scenes or cuts. The output of narrative flow submodule 320 may be a portion of a directorial style sheet that may be added to by the subsequent submodules within natural language processing engine 302. Scene determination submodule 321 may be used to generate a series of scenes that capture the narrative flow outlined by narrative flow submodule 320. Scene transition submodule 322 which may be used to determine the types of transitions and/or dissolves to be used in between story beats, scenes, and/or shots. Expressive edits submodule 323 may be used to determine the manner and frequency of expressive edits. In the context of this application, the term “expressive edit” may be used to define editing techniques used to invoke emotional impact and narrative rhythm as opposed to continuity. An exemplary expressive edit may be juxtaposition of two points of view. Finally, audio and overdubs submodule 324 may be used to specify language and or audio type to be included in the video content.

FIG. 3B depicts a flow chart of the creation of video content based on the directorial style sheet.

Directorial style sheet 303A and in some cases sequenced video footage 304 may be sent to editing (“Editing module”) 212C. Editing module may comprise several subroutines or submodules include scene classification submodule 325, determination of style applicability submodule 326, application of style submodule 327. Scene classification submodule 325 may be used to recognize and partition scenes of a video file. Determination of style applicability submodule 326 may be used to determine which aspects of the directorial style sheet may be applied to the specific video file be edited by editing module 212C. Application of style submodule 327 may apply specific aspects of directorial style sheet 303A by performing API calls (328) to third party editing software 305. Third party editing software 305 may produce edited footage 306, which may be analyzed at 307 and 308. If at 308 it is determined that edited footage 306 does not match the style/instructions as provided by directorial style sheet 303A, the footage may once again be processed by editing module 212C and routed to the appropriate third party editing software 305 to produce the intended effects/style. If it is determined that the style of editing footage 306 matches the style/instructions as provided by directorial style sheet 303A, the footage may be considered completed.

It may be advantageous to set forth definitions of certain words and phrases used in this patent document. The term “couple” and its derivatives refer to any direct or indirect communication between two or more elements, whether or not those elements are in physical contact with one another. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. Whether in the written description or the claims, the terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases with respect to claims.

If present, use of ordinal terms such as “first,” “second,” “third,” etc., in the claims to modify a claim element does not by itself connote any priority, precedence or order of one claim element over another or the temporal order in which acts of a method are performed. These terms are used merely as labels to distinguish one claim element having a certain name from another element having a same name (but for use of the ordinal term) to distinguish the claim elements. As used in this application, “and/or” means that the listed items are alternatives, but the alternatives also include any combination of the listed items.

As used herein and throughout this disclosure, the term “computing device” may be used to refer to any electronic device capable of communicating across a network. A computing device may have a processor, a memory, a transceiver, an input, and an output. Examples of such devices include, without limitation, computer servers, Raspberry Pi devices, network switches, and gateways, cellular telephones, personal digital assistants (PDAs), portable computers, and more generally, any device with sufficient compute, storage, and communication capability to participate in processing and network functions may qualify as a computing device.

The memory stores applications, software, or logic. Examples of device memories that may comprise logic include RAM (random access memory), flash memories, ROMS (read-only memories), EPROMS (erasable programmable read-only memories), and EEPROMS (electrically erasable programmable read-only memories). A transceiver includes but is not limited to cellular, GPRS, Bluetooth, and Wi-Fi transceivers.

Examples of processors are computer processors (processing units), microprocessors, digital signal processors, controllers and microcontrollers, etc. For purposes of this document, the term “processor” may refer to a real hardware processor or a virtual processor, unless expressly stated otherwise. A virtual machine may include one or more virtual hardware devices, such as a virtual processor and a virtual memory in communication with the virtual processor.

“Logic” as used herein and throughout this disclosure, refers to any information having the form of instruction signals and/or data that may be applied to direct the operation of a processor. Logic may be formed from signals stored in a device memory. Software is one example of such logic. Logic may also be comprised by digital and/or analog hardware circuits, for example, hardware circuits comprising logical AND, OR, XOR, NAND, NOR, and other logical operations. Logic may be formed from combinations of software and hardware. On a network, logic may be programmed on a server, or a complex of servers. A particular logic unit is not limited to a single logical location on the network.

Computing devices may communicate with one another and with other elements of the system via one or more networks. In some embodiments, communication occurs over a Transmission Control Protocol (TCP) network. In other embodiments, communication may utilize additional or alternative protocols and networking technologies, including User Datagram Protocol (UDP), Hypertext Transfer Protocol (HTTP/HTTPS), Message Queuing Telemetry Transport (MQTT), WebSocket, cellular networks (e.g., 4G, 5G), wireless local area networks (Wi-Fi), wired Ethernet, or other communication frameworks suitable for enabling peer-to-peer and client-server interactions among edge nodes and between computing devices and external systems. A “network” can include broadband wide-area networks, local-area networks, and personal area networks. Communication across a network can be packet-based or use radio and frequency/amplitude modulations using appropriate analog-digital-analog converters and other elements. Examples of radio networks include GSM, CDMA, Wi-Fi and BLUETOOTH® networks, with communication being enabled by transceivers. A network typically includes a plurality of elements such as servers that host logic for performing tasks on the network. Computing may be placed at several logical points on the network. Computing devices may further be in communication with databases and can enable communication devices to access the contents of a database. For instance, a computing device hosts or is in communication with a database hosting users' data which is serviced through a network.

In the context of this application the phrase “digital media platforms” may be used to refer to any of connected television (CTV), social media, digital streaming, and retail-media networks.

In the context of this application, the phrase “visual characteristic” may be used to refer to any perceptible feature or video or graphical content that affects the appearance of a visual element. Visual characteristics may include but are not limited to, color scheme, brightness, contrast, saturation, lighting resolution, frame composition, aspect ratio, motion or animation style, visual effects, transitions, typography, layout or on-text. Visual characteristics may be static or dynamic and may vary across different frames or segments of a video.

In the context of this application, the phrase “auditory characteristic” may be used to refer to any perceptible attribute of audio content that affects the sound or auditory experience of a video. Auditory characteristics may include, but are not limited to, volume, pitch, tone, speech, speech cadence, background music, sound effects, voice, synchronization timing, or audio mixing levels. Auditory characteristics may apply to spoken dialogue, narration, music or ambient sounds associated with video content.

In the context of this application, the phrase “visual component” refers to the portion of video content that conveys information or expression through images, motion graphics or any visual medium. The visual component may include recorded footage, computer generated imagery (CGI), animations, transitions, text overlays, images, digital assets or any combination thereof. The visual component is typically rendered as sequence of visual frames in a video timeline.

In the context of this application, the phrase “auditory component” may be used to refer to the portion of video content that conveys information or expression through sound. The audio component may include speech, narration, dialogue, music, sound effects, background noise or any combination thereof. The audio component may be aligned temporally with the visual component to produce a coherent video content or a coherent audiovisual experience.

In the context of this application the phrase “natural language instruction” may be used to define any instruction given to an artificial intelligence module, generative artificial intelligence module or large language model which may tokenized or vectorized in order to inform

Throughout this description, the aspects, embodiments, or examples shown should be considered as exemplars, rather than limitations on the apparatus or procedures disclosed or claimed. Although some of the examples may involve specific combinations of method acts or system elements, it should be understood that those acts and those elements may be combined in other ways to accomplish the same objectives.

Acts, elements, and features discussed only in connection with one aspect, embodiment or example are not intended to be excluded from a similar role(s) in other aspects, embodiments, or examples.

Aspects, embodiments, or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

If means-plus-function limitations are recited in the claims, the means are not intended to be limited to the means disclosed in this application for performing the recited function, but are intended to cover in scope any equivalent means, known now or later developed, for performing the recited function.

Claim limitations should be construed as means-plus-function limitations only if the claim recites the term “means” in association with a recited function.

If any presented, the claims directed to a method and/or process should not be limited to the performance of their steps in the order written, and one skilled in the art can readily appreciate that the sequences may be varied and still remain within the spirit and scope of the present invention.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments, and/or examples. Hence, the scope of the invention is defined by the accompanying claims and their equivalents. Further, each and every claim is incorporated as further disclosure into the specification.

What is claimed is:

1. A method for creating and editing video content, the method being operable on a computer system comprising at least a processor, a memory and a computer program comprising processor-executable instructions stored on a non-transitory processor-readable medium, the method comprising:
receiving, a natural language instruction describing a desired characteristic of video content;
generating, by a natural language processing engine, a structured script file based at least in part on the natural language instruction;
generating, by a storyboarding module, a storyboard associated with the structured script file;
generating, by a virtual component production module, a virtual component associated with the storyboard,
generating, by a virtual component animation module, an intermediate video sequence based at least in part on the virtual component and the storyboard, the intermediate video sequence comprising a visual component and an auditory component;
generating, by a post-production module, a plurality of modified video sequences wherein each modified video sequence differs from the others and the intermediate video sequence in at least one visual or auditory characteristic;
determining, by a distribution optimization module, one or more digital media platforms for distribution of the plurality of modified video sequences;
distributing the plurality of modified video sequences to the one or more digital media platforms;
collecting performance data from each of the one or more digital media platforms associated with the plurality of modified video sequences;
analyzing the performance data to identify at least one performance trend; and
adjusting one or more of the natural language processing engine, storyboarding module, virtual component production module, virtual component animation module or post-production module based at least in part on the performance data or the at least one performance trend.

2. The method of claim 1, further comprising: generating, by a market testing module, a predicted audience response to each of the modified video sequences, the predicted audience response comprising one or more predictive performance metrics and associated confidence intervals, wherein the predicted audience response is used to refine at least one visual or audio characteristic of each of the plurality of modified video sequences.

3. The method of claim 1, further comprising: generating, by an emotion intelligence module, an affect vector representing emotional tone characteristics encoded as numerical values for at least a portion of the structured script file or storyboard, and revising at least one visual or audio characteristic of the structured script file or storyboard based on the affect vector.

4. The method of claim 1, wherein the collecting of performance data comprises segmenting the performance data by at least one of time-of-day, geographic region, or audience demographic to facilitate identification of a highest performing modified video sequence within each segment.

5. The method of claim 1, further comprising: storing the performance data in a data repository for subsequent analysis or model retraining.

6. The method of claim 1, wherein the desired characteristic of video content is a descriptor of brand identity, tone, target demographic, duration, digital media platform of content objective.

7. The method of claim 1, further comprising: generating a new plurality of modified video sequences based at least in part on the performance data.

8. A method for editing video content, the method being operable on a computer system comprising at least a processor, a memory and a computer program comprising processor-executable instructions stored on a non-transitory processor-readable medium, the method comprising:
generating, by a generative artificial intelligence orchestration layer, a plurality of variants of a base video content, the base video content comprising a visual component and an auditory component, each variant of said plurality of variants differing from the base video content and one another in at least one visual or auditory characteristic;
distributing the plurality of variants to a plurality of digital media platforms;
collecting performance data corresponding to each of the plurality of variants distributed to the plurality of digital media platforms;
comparing the performance data corresponding to each of the plurality of variants to identify a highest performing variant; and
modifying the generative artificial intelligence orchestration layer based at least in part on the highest performing variant to improve subsequent video content generation.

9. The method of claim 8, wherein modifying the generative artificial intelligence orchestration layer comprises retraining at least one machine learning model or updating model weights based on said highest performing variant.

10. The method of claim 8, further comprising: storing the performance data in a database or data repository for subsequent analysis or model retraining.

11. The method of claim 8, wherein the generating, distributing, collecting comparing and modifying steps are performed cyclically to enable continuous optimization of video-content performance.

12. The method of claim 8, wherein the performance data is segmented by at least one of time-of-day, geographic region or audience demographic to identify a highest performing variant within each segment to facilitate modification of said generative artificial intelligence orchestration layer.

13. The method of claim 8, wherein each of the plurality of variants has a duration of less than ninety seconds.

14. A method for creating video content, the method being operable on a computer system comprising at least a processor, a memory and a computer program comprising processor-executable instructions stored on a non-transitory processor-readable medium, the method comprising:
receiving, a natural language instruction describing a natural language characteristic of video content;
generating, by a natural language processing engine, a structured script file based at least in part on the desired characteristic of video content, the structured script file comprising at least one story beat;
generating a storyboard based on the structured script file, the storyboard comprising at least one storyboard frame;
generating a virtual component based on the storyboard;
generating an intermediate video sequence based at least in part on the virtual component and the storyboard, the virtual component comprising a visual component and an auditory component; and
refining the intermediate video sequence to produce a modified video sequence by applying at least one post-processing effect.

15. The method of claim 14, wherein the natural language processing engine is trained on historical advertisement scripts, associated performance data and audience engagement metrics.

16. The method of claim 14, wherein the virtual component comprises a three-dimensional digital asset stored in at least one of a .FBX, .GLTF or .USD file format.

17. The method of claim 14, wherein the post-processing effect comprises at least one of a color-grading adjustment, an audio level normalization, a visual effects enhancement, a transition adjustment, a lighting correction, a voiceover synchronization or a subtitle operation.

18. The method of claim 14, further comprising: generating by an emotion intelligence module, an affect vector representing emotional tone characteristics encoded as numerical values for at least a portion of the structured script file or storyboard, and modifying at least one visual or audio characteristic of the structured script file or storyboard based on the affect vector.

19. The method of claim 14, further comprising: generating by a market testing module, a predicted audience response to the modified video sequence, the predicted audience response comprising one more predictive performance metrics and associated confidence intervals wherein the predicted audience response is used to refine at least one visual or auditory characteristic of each of the modified video sequence.

20. The method of claim 19, further comprising: determining, by a distribution optimization module, an optimal digital media platform for distributing the modified video sequence, the optimal digital media platform determined at least on the predicted audience response.
